(19) United States
(12) Patent Application Publication
(10) Pub. No.: US 2021/0312215 A1
(43) Pub. Date: Oct. 7, 2021

(54) METHOD FOR BOOK RECOGNITION AND BOOK READING DEVICE

(71) Applicant: BEIJING LING TECHNOLOGY CO., LTD., Beijing (CN)

(72) Inventors: Hui ZHENG, Beijing (CN); Jiawei GU, Beijing (CN)

(21) Appl. No.: 17/267,742

(22) PCT Filed: Nov. 21, 2018
(86) PCT No.: PCT/CN2018/116584

§ 371 Date: Feb. 10, 2021

(30) Foreign Application Priority Data
May 4, 2018 (CN) 201810421722.2

(51) Int. Cl. G06K 9/46; G06K 9/62; G06K 9/00; G06N 3/08

(52) U.S. Cl. CPC G06K 9/4676; G06N 3/08; G06K 9/00469; G06K 9/6215

(57) ABSTRACT

A method for book recognition is disclosed. The method comprises: performing adaptive equalization on an image with stability captured by the lens; correcting the image captured by the lens; detecting feature points of the corrected image captured by the lens; extracting features of the feature points of the corrected image captured by the lens; and determining an index in the book model corresponding to the corrected image captured by the lens based on the book model and the features of the feature points of the corrected image captured by the lens.

The present application claims benefits and priority of Chinese Patent Application No. 2018104217222 filed on May 4, 2018.

### TECHNICAL FIELD

The present application relates to, in particular, a method for book recognition and book reading device.

### BACKGROUND

FIG. 1 shows the block diagram of the computer composition, showing the main components of the computer. In FIG. 1, a processor 110, an internal memory 105, a bus bridge 120, and a network interface 115 are connected to a system bus 140. A bus bridge 120 is used to bridge the system bus 140 and an I/O bus 145. An I/O interface is connected to the I/O Bus 145. A USB interface and an external memory are connected to the I/O interface. In FIG. 1, the processor 110 may be one or more processors, each processor may have one or more processor cores. The internal memory 105 is a volatile memory, such as a register, a buffer, and various types of random access memories. The data in the internal memory 105 includes operating system and application programs when the computer is running. The network interface 115 may be an Ethernet interface, an optical fiber interface, etc. The system bus 140 may be used to transmit data information, address information, and control information. The bus bridge 120 can be used for protocol conversion to convert the system bus protocol to an I/O protocol or convert the I/O protocol to a system bus protocol for data transmission. The I/O bus 145 is used to transmit data information and control information, and can also be a bus termination resistor or circuit to reduce signal reflection interference. The I/O interface 130 is mainly connected to various external devices such as a keyboard, a mouse, a sensor, etc. A flash memory can be connected to the I/O bus through the USB interface. The external memory may be a non-volatile memory such as a hard disk, an optical disk, etc. After the computer is turned on, the processor can read the data stored in the external memory into the internal memory and process the computer instructions stored therein to complete the functions of the operating system and the application programs. The example computer may be a desktop, a laptop, a tablet, a smart phone, and the like.

With the development of artificial intelligence technology, more and more image processing methods based on the aforementioned computer structures emerge. One of them is the processing of children's picture books. For the picture book recognition, the problem to be solved is how to quickly distinguish whether the pictures captured by the camera include a picture book and confirm which page of the picture book is. This is actually understood as a picture retrieval problem, that is, how to select from the picture book library a candidate picture (or an index thereof) having the same content as the queried picture.

### SUMMARY

Embodiments of the present application provide a method for establishing a picture book model, a reading robot, and a storage device to speed up the image query.

The present application provides a method for establishing a book model, comprising:

detecting feature points of each training image in a book library;

extracting features of feature points of each training image in the book library;

filtering a specific number of features for each training image; and

establishing a book model based on the specified number of features.

Optionally, detecting feature points of each training image in a book library comprises:

for each book in the book library, detecting feature points of a training image corresponding to cover page of the book; and

for each book in the book library, detecting feature points of a training image corresponding to content page of the book.

Optionally, detecting feature points of each training image in a book library comprises: detecting feature points of books in the book library by the HARRIS corner detection algorithm, the FAST feature point detection algorithm, the SURF feature point detection algorithm, and/or the AKAZE feature point detection algorithm.

Optionally, extracting features of feature points of each training image in the book library comprises: extracting features of feature points of each training image by a feature extraction algorithm corresponding to the feature points, or by a deep-learning based algorithm.

Optionally, filtering a specific number of features for each training image comprises:

matching similarity between each feature of each training image and each feature of other training images in the book library;

for each feature of each training image, counting the number of features of other training images in the book library that meet the similarity matching conditions; and

for each training image, selecting the top K features with the smallest number of features that meet the similarity matching conditions as a specific number of features for each training image, K being a positive integer.

Optionally, establishing a book model based on the specified number of features comprises: indexing the specific number of features according to an approximate nearest neighbor search method to obtain the book model.

Optionally, establishing a book model based on the specified number of features comprises:

training the specific number of features with a bag-of-words model or Fisher vector to convert the features of each training image into fixed-length vector features, thereby establishing the book model.

Optionally, establishing a book model based on the specified number of features comprises:

establishing a book cover model based on the features of cover of each book; and

establishing a book model for each book based on features of the cover page and content page of each book.

Optionally, the method further comprises:

reducing dimensions of the extracted features of each training image in the book library.

The present application provides a book recognition method. The method comprises:

performing adaptive equalization on an image with stability captured by the lens;

correcting the image captured by the lens;

detecting feature points of the corrected image captured by the lens;

extracting features of the feature points of the corrected image captured by the lens; and

determining an index in the book model corresponding to the corrected image captured by the lens based on the book model obtained by the method and the features of the feature points of the corrected image captured by the lens.

Optionally, determining an index in the book model corresponding to the corrected image captured by the lens based on the book model and the features of the feature points of the corrected image captured by the lens comprises:

determining an index of the corresponding book cover in the book cover model corresponding to the image based on the features of the feature points of the corrected image captured by the lens;

determining the book model corresponding to the corrected image captured by the lens based on the index of the book cover; and

based on features of a subsequent image captured by the lens and the corresponding book model, determining an index in the book model corresponding to the subsequent image.

Optionally, the image with stability captured by the lens is an image having a number of foreground points less than a preset value.

The present application provides a book reading device, comprising:

a storage device configured to store a program; and

a central processing unit configured to execute the program to implement a book model establishment method and/or a book recognition method.

The present application provides a storage device having a program stored thereon which, when executed by a processor, implements a book model establishment method and/or a book recognition method.

The present application can adapt to a variety of lighting and environmental changes, and can effectively compress the number of features, ensuring greater database support and faster matching speed in conditions where the memory is limited.

### BRIEF DESCRIPTION OF THE DRAWINGS

The drawings described herein are provided to provide a further understanding of the present application, and constitute a part of the present application. The exemplary embodiments of the present application and descriptions thereof are used to explain the present application and do not constitute improper limitations to the present application. In these drawings:

FIG. 1 is a block diagram of a computer composition provided by the present application;

FIG. 2 is a flow chart for the establishment of a picture book model;

FIG. 3 is a flow chart for the picture book recognition; and

FIG. 4 shows the image stability detection process.

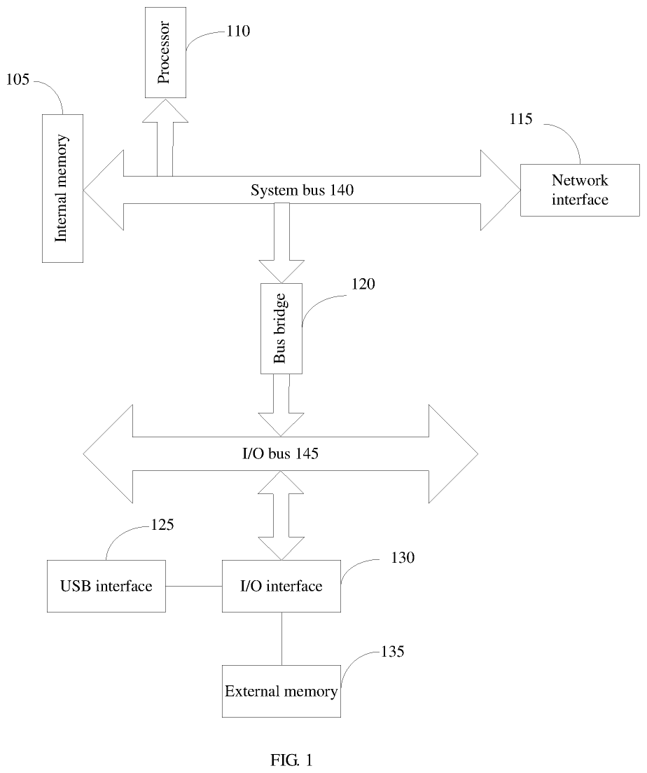

### DETAILED DESCRIPTION OF THE INVENTION

To make the purpose, technical solutions, and advantages of the present application clearer, the technical solutions of the present application will be described clearly and completely in conjunction with specific embodiments of the present application and corresponding drawings. Obviously, the described embodiments are merely a part of the embodiments of the present application and not all of them. All other embodiments obtained by a person of ordinary skill in the art based on the embodiments of the present application without creative efforts shall fall within the protection scope of the present application.

The main idea of image retrieval is to extract features from the image, and match the features with those of the candidate image to select an image having the most similar features as the retrieval results.

The image retrieval algorithm based on local feature point matching is the most classic image retrieval algorithm. The local feature point is the local expression of the image feature. It can only reflect the local specialty of the image, so it is very suitable for image matching, image retrieval and other applications. Mainstream local feature point detection algorithms include SIFT detection algorithm, SURF detection algorithm, ORB detection algorithm, AKAZE detection algorithm, etc. These features have the characteristics of scale and rotation invariance and are thus very suitable for image matching applications.

If N feature points are detected for an image, each of the feature points having a dimension of D, then the features of this image can be represented by characteristics quantity of N*D. N can be different for each image and D is a fixed value. For image match, the actual calculation is to obtain the matching result of the two feature point sets.

In the image retrieval system, since the database is relatively large, model algorithms such as the bag-of-words model and the Fisher vector model are also used to transform the original features to obtain fixed dimension feature vectors, which can effectively improve the matching speed.

In order to achieve the query of pictures, it is generally required to train the picture book models such as index model, bag-of-words model, and Fisher vector model with training images. These models can be used to query images and speed up the query. Preferably, the picture book model can be established for each picture book. The amount of calculation can be reduced and the speed of retrieval can be accelerated by retrieving the cover first and then retrieving the content.

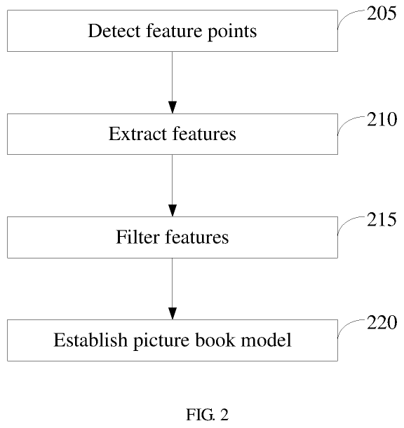

The method for establishing a picture book model provided by this application is shown in FIG. 2, comprising steps described hereunder.

Step 205, at which feature points of each training image in the picture book library are detected. The picture book library includes images of a number of picture books. These images are scanned images free of background noise and are called training images. Feature points, also known as key points, points of interest, are points that are prominent in the image and have representative significance. Each training image can be considered as one type. Feature points can be detected for each training image by, for example, HARRIS corner detection algorithm, SIFT feature point detection algorithm, SURF feature point detection algorithm, ORB feature point detection algorithm, and AKAZE feature point detection algorithm.

Step 210, at which feature points are extracted for each training image in the picture book library. The feature extraction may be carried out using feature extraction algorithms corresponding to the feature points, among which the SIFT feature extraction algorithm, SURF feature extraction algorithm, and AKAZE feature extraction algorithm provide better matching effect, and the ORB feature extraction algorithm provides faster matching speed. In addition, image features can also be extracted through deep learning methods. For example, feature extraction may be implemented using convolutional neural networks.

Step 215, at which a specific number of features, such as K features, are filtered for each training image. The feature points are local features. It is possible that multiple pages may have similar (or even the same) content and the feature points of different pages may be similar with each other, therefore the uniqueness of the feature points is the key to distinguishing the picture book pages. The feature filtering corresponding to the feature points is to select the features of the feature points with high uniqueness and delete the features of the same or similar feature points. For a single training image, the features of the extracted feature points are matched with other images in the picture book library. The number of matching times of the features corresponding to each feature point of the training image is recorded. If the number of matching times is large, it means that the feature point is not a “Special points” and thus does not have a good specificity. The feature matching times of the feature points are ascended and the features of the top K feature points are retained. In the matching, for each feature, the feature of the nearest neighbor feature point is found among the features of all other images, and the distance is d. If d<TH, it is considered that the features match, TH being a threshold.

S220, at which a picture book model is established based on the specific number of features. For example, a nearest neighbor search method is used to create an index such as a linear index, a KD-Tree index, a K-means index, a compound index, an LSH index, and the like. Optionally, when the database is relatively large, the local features are vector-normalized through the bag-of-words model to form a feature vector with fixed dimension.

Optionally, PCA dimension reduction processing may also be performed in order to make the extracted feature have less dimensions.

After the picture book model is established, picture book recognition can be performed based on this model. FIG. 3 shows a picture book recognition method comprising steps described hereunder.

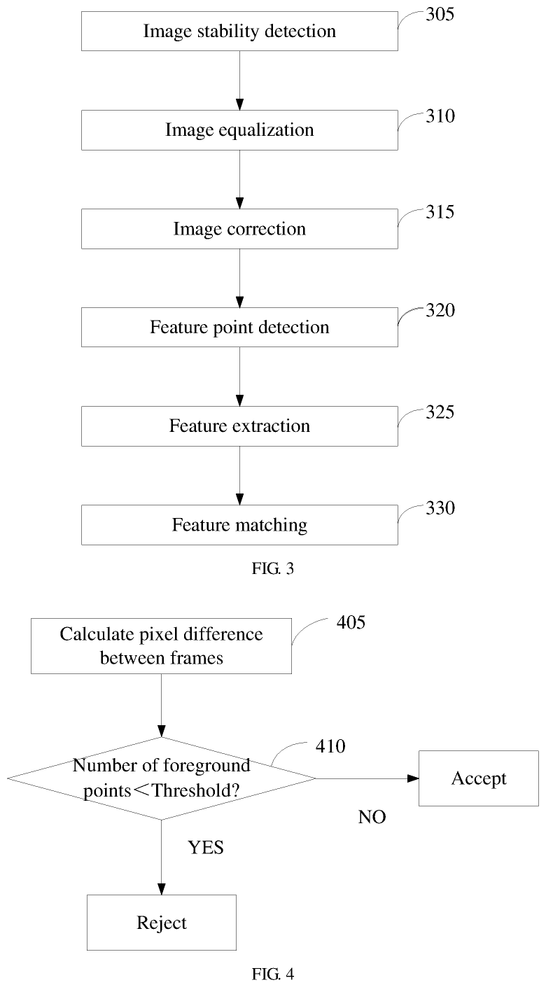

Step 305, at which the image stability detection is performed on the images captured by the camera or the camera lens, such that the unstable images are rejected. The specific flowchart is as shown in FIG. 4. Motion detection is employed to determine whether the image is stable, including Step 405, at which a pixel difference between two frames is calculated. For example, provided that the current image is f1, the last input image is f0, the image size is w*h, where w is the image width, h is the image height, then diff(x,y)=|f0(x,y)−f1(x,y)|, which represents the pixel difference at the x, y positions. If diff(x,y)>th_d, where th_d is a preset value, the point is considered to be a foreground point. Step 410, at which it is determined whether the number T of foreground points meets the requirement. For example, if T<th_p, where th_p is a preset value, then the image is considered to be stable and is accepted for recognition, otherwise the image is rejected.

Step 310, at which image equalization is performed on the image with stability. The threshold is adaptively adjusted according to the brightness characteristics of the input image, whereby the contrast of over-dark images can be effectively improved and the accuracy of feature point detection can be enhanced.

Step 315, at which the equalized image is corrected. According to the pre-determined camera world coordinate system, the image is affine-transformed so that the viewing angle of the image is consistent with the viewing angle of the images in the picture book library, thereby improving the matching accuracy.

Step 320, at which feature points of the corrected image are detected. The feature point detection may be performed using the detection method shown in FIG. 2.

Step 325, at which features of the feature points of the image are extracted. The feature extraction may be performed using the detection method shown in FIG. 2.

Step 330, at which feature matching is performed based on the picture book model and the features to determine the picture book. In the feature matching, the matching method used in filtering the feature points in FIG. 2 may be used. The feature points in the image are matched with the picture book model. When the matching result meets the requirements, the image is determined to correspond to a certain page of the picture book.

In the specific implementation process, a picture book cover model is separately established for the cover of the picture book and a picture book model is then established for each picture book. In the recognition process, matching is preferably performed based on the picture book cover model to determine an index of the corresponding picture book cover, and then the picture book model corresponding to the picture book is determined according to the index of the picture book cover. Preferably, the matching is performed according to the picture book model. If there is no matching result, the matching can be performed again according to the picture book cover model. After the cover is determined, the above process is repeated to accelerate the matching speed of the content of the picture book.

The present application provides a computer-readable storage medium storing a computer program which, when executed by a processor, performs the steps of the picture book model establishment method, and the steps of the picture book identification method.

The present application provides a picture book reading robot including a central processing unit, and a storage device storing a computer program. When the central processing unit executes the computer program, the processor is configured to implement the steps of the picture book model establishment method, and/or the steps of the picture book recognition method.

In a typical configuration, the computing device includes one or more processors (CPUs), input/output interfaces, network interfaces, and memory.

The memory may include non-volatile memory in a computer-readable medium, random access memory (RAM), and/or non-volatile memory, such as read only memory (ROM) or flash memory (flash RAM). Memory is an example of a computer-readable medium.

The computer-readable medium include permanent and non-permanent, removable and non-removable medium. Information storage may be implemented by any method or technology. The information may be computer readable instructions, data structures, modules of a program or other data. Examples of the storage medium for computers include, but are not limited to, phase change memory (PRAM), static random access memory (SRAM), dynamic random access memory (DRAM), other types of random access memory (RAM), read-only memory (ROM), electrically erasable programmable read only memory (EEPROM), flash memory or other memory technology, CD-ROM, DVD, or other optical storage, magnetic tape cartridges, tape magnetic disk storage or other magnetic storage devices or any other non-transport media may be used to store information that may be accessed by a computing device. As defined herein, the computer-readable medium does not include transitory media, such as modulated data signals and carrier waves.

It should also be noted that the terms “include”, “comprise” or any other variations thereof are intended to cover non-exclusive inclusions so that a process, method, commodity, or equipment that includes a range of elements includes not only those elements but also other elements that are not explicitly listed or that are inherent to such processes, methods, goods, or equipment. In the case of no more limitation, the element defined by the sentence “includes a . . . ” does not exclude the existence of another identical element in the process, method, goods, or equipment including the element.

Those skilled in the art should understand that the embodiments of the present application may be provided as a method, system or computer program product. Thus, the application can take the form of an entirely hardware embodiment, an entirely software embodiment or an embodiment combining software and hardware aspects. Moreover, the present application may take the form of a computer program product embodied on one or more computer-usable storage medium (including, but not limited to, disk storage, CD-ROM, optical memory, etc) having computer-usable program code embodied therein.

The above description is only examples of the present application and is not intended to limit the present application. For a person skilled in the art, the present application may have various changes and variations. Any modification, equivalent replacement, and improvement made within the spirit and principle of the present application should be included in the scope of the claims of the present application.

1. A book model establishment method, comprising: detecting feature points of each training image in a book library; extracting features of feature points of each training image in the book library; filtering a specific number of features for each training image; and establishing a book model based on the specified number of features.

2. The method according to claim 1, wherein detecting feature points of each training image in a book library comprises: for each book in the book library, detecting feature points of a training image corresponding to cover page of the book; and for each book in the book library, detecting feature points of a training image corresponding to content page of the book.

3. The method according to claim 1, wherein detecting feature points of each training image in a book library comprises: detecting feature points of books in the book library by the HARRIS corner detection algorithm, the FAST feature point detection algorithm, the SURF feature point detection algorithm, and/or the AKAZE feature point detection algorithm.

4. The method according to claim 3, wherein extracting features of feature points of each training image in the book library comprises: extracting features of feature points of each training image by a feature extraction algorithm corresponding to the feature points, or by a deep-learning based algorithm.

5. The method according to claim 1, wherein filtering a specific number of features for each training image comprises: matching similarity between each feature of each training image and each feature of other training images in the book library; for each feature of each training image, counting the number of features of other training images in the book library that meet the similarity matching conditions; and for each training image, selecting the top K features with the smallest number of features that meet the similarity matching conditions as a specific number of features for each training image, K being a positive integer.

6. The method according to claim 1, wherein establishing a book model based on the specified number of features comprises: indexing the specific number of features according to an approximate nearest neighbor search method to obtain the book model.

7. The method according to claim 1, wherein establishing a book model based on the specified number of features comprises: training the specific number of features with a bag-of-words model or Fisher vector to convert the features of each training image into fixed-length vector features, thereby establishing the book model.

8. The method according to claim 1, wherein establishing a book model based on the specified number of features comprises: establishing a book cover model based on the features of cover of each book; and establishing a book model for each book based on features of the cover page and content page of each book.

9. The method according to claim 1, further comprising: reducing dimensions of the extracted features of each training image in the book library.

10. A book recognition method, comprising: performing adaptive equalization on an image with stability captured by the lens; correcting the image captured by the lens; detecting feature points of the corrected image captured by the lens; extracting features of the feature points of the corrected image captured by the lens; and determining an index in the book model corresponding to the corrected image captured by the lens based on the book model obtained by the method according to claim 1 and the features of the feature points of the corrected image captured by the lens.

11. The method according to claim 10, wherein determining an index in the book model corresponding to the corrected image captured by the lens based on the book model and the features of the feature points of the corrected image captured by the lens comprises: determining an index of the corresponding book cover in the book cover model corresponding to the image based on the features of the feature points of the corrected image captured by the lens; determining the book model corresponding to the corrected image captured by the lens based on the index of the book cover; and based on features of a subsequent image captured by the lens and the book model, determining an index in the book model corresponding to the subsequent image.

12. The method according to claim 10, wherein the image with stability captured by the lens is an image having a number of foreground points less than a preset value.

13. A book reading device, comprising: a storage device configured to store a program; and a central processing unit configured to execute the program to implement the book model establishment method according to claim 1 and/or the book recognition method according to claim 10.

14. A storage device having a program stored thereon which, when executed by a processor, implements the book model establishment method according to claim 1.

15. A storage device having a program stored thereon which, when executed by a processor, implements the book recognition method according to claim 10.
